(19) United States
(12) Patent Application Publication
(10) Pub. No.: US 2025/0362494 A1
(43) Pub. Date: Nov. 27, 2025

(54) SCANNING OPTICAL DEVICE AND IMAGE FORMING APPARATUS

(71) Applicant: CANON KABUSHIKI KAISHA, Tokyo (JP)

(72) Inventor: SHUNSUKE TANAKA, Kanagawa (JP)

(21) Appl. No.: 19/196,300

(22) Filed: May 1, 2025

(30) Foreign Application Priority Data
May 21, 2024 (JP) 2024-082854

(51) Int. Cl. G02B 26/12; G03G 15/043

(52) U.S. Cl. CPC G02B 26/127; G03G 15/0435; G03G 2215/0404

(57) ABSTRACT

A scanning optical device includes a deflector to deflect a laser light from a lase element, a detector to output a synchronizing signal, a switch provided in a supplying path which supplies a current to the laser element and to be switched to an ON state and to an OFF state. A protection circuit to which the synchronizing signal is inputted from the detector changes an output when a predetermined time depending on a time constant there of elapses, and of which the output is connected to the switch. The protection circuit changes the output, in a case in which the synchronizing signal is not inputted from the detectors for the predetermined time from when the switch is switched to the ON state by a control signal, and thereby the switch is switched to the OFF state irrespective of a state of the control signal.

### FIELD OF THE INVENTION AND RELATED ART

The present invention relates to a scanning optical device and an image forming apparatus.

As for products to which a laser is mounted, for a purpose of preventing an occurrence of injury to a user of the products, in the IEC (International Electrotechnical Commission) 60825-1, safety standards are defined. In JIS (Japanese Industrial Standards), based on the IEC60825-1, in JISC6802, laser products are classified (laser class) according to risk, and safety countermeasures required for each class are defined. The laser classes are classified from Class 1 to Class 4 according to the risk, and Class 4 is defined as the most dangerous. The risk of the laser class is determined by power emitted by a laser, a wavelength of the laser and emission duration. A laser commonly used in a laser beam printer falls into Class 3. Class 3 is further divided into, in descending order of the risk, Class 3B and Class 3R. In Class 3B, an interlock mechanism constituted by a laser shutter, etc. is required, while in Class 3R, the interlock mechanism is not required. In order to achieve downsizing and price reduction of a product to which a laser is mounted, it is important to design the laser in Class 3R or below.

A scanning optical device mounted to a laser beam printer scans a laser with a rotatable polygon mirror, which is rotationally driven, and emits a light outside a laser scanning device. Even though a laser power emitted from a laser is the same, an exposed light amount per unit time and unit area becomes smaller in a scanning state than in a non-scanning state (stationary state). In other words, in terms of laser light exposure, a state of a stationary light is determined to be riskier. Therefore, it is relatively easy to satisfy requirements for Class 3R as long as the laser does not emit when the laser is in the non-scanning state. Thus, it is proposed that a method in which a rotation state output signal portion, which notifies a rotation state, is provided to a driving device, which rotationally drives a rotatable polygon mirror, and only in a case in which a rotation state output state from a rotational drive signal indicates a normal rotation, electric power is supplied to a laser emitting portion (see Japanese Patent Application Laid-Open No. 2006-088441).

### SUMMARY OF THE INVENTION

The present invention provides a means which makes a safety circuit of a laser scanning device operate reliably even in a case in which there is an abnormality in a firmware operation when an abnormality occurs during laser emission.

The present invention has the following configuration.

A scanning optical device comprising: a laser element; a deflector configured to deflect a light emitted from the laser element; an output unit configured to receive the light deflected and scanned by the deflector and to output a synchronizing signal; a switch provided in a supplying path which supplies a current to the laser element and configured to be switched to an ON state in which the current is supplied to the laser element and to an OFF state in which the supply of the current to the laser element is shut off, a control unit configured to control the ON state and the OFF state of the switch by a control signal; and a protection circuit to which the synchronizing signal is inputted from the output unit, configured to change an output when a predetermined time depending on a time constant thereof elapses, and of which the output is connected to the switch, wherein the protection circuit changes the output, in a case in which the synchronizing signal is not inputted from the output unit for the predetermined time from when the switch is switched to the ON state by the control signal of the control unit, and thereby the switch is switched to the OFF state irrespective of a state of the control signal of the control unit.

An image forming apparatus comprising: the scanning optical device; an image bearing member on which an electrostatic latent image is formed by the scanning optical device; a developing means configured to develop the electrostatic latent image with toner and form a toner image; a transfer means configured to transfer the toner image onto a transfer material; and a fixing means configured to fix the toner image transferred by the transfer means.

According to the present invention, when an abnormality occurs during laser emission, even in a case in which there is an abnormality in a firmware operation, it becomes possible to make the safety circuit of the laser scanning device operate reliably.

Further features of the present invention will become apparent from the following description of exemplary embodiments with reference to the attached drawings.

### BRIEF DESCRIPTION OF THE DRAWINGS

FIG. 1 is an image view of an image forming apparatus in Embodiments 1 and 2.

FIG. 2 is an image view of a scanning optical device in the Embodiments 1 and 2.

FIG. 3 is a control block diagram of the scanning optical device in the Embodiments 1 and 2.

FIG. 4 is a configuration view of a safety circuit in the Embodiment 1.

FIG. 5 is a view illustrating a relationship between a BD signal and a charge voltage in the Embodiment 1.

FIG. 6 is a configuration view of a safety circuit in the Embodiment 2.

### DESCRIPTION OF THE EMBODIMENTS

### Embodiment 1

### [Image Forming Apparatus]

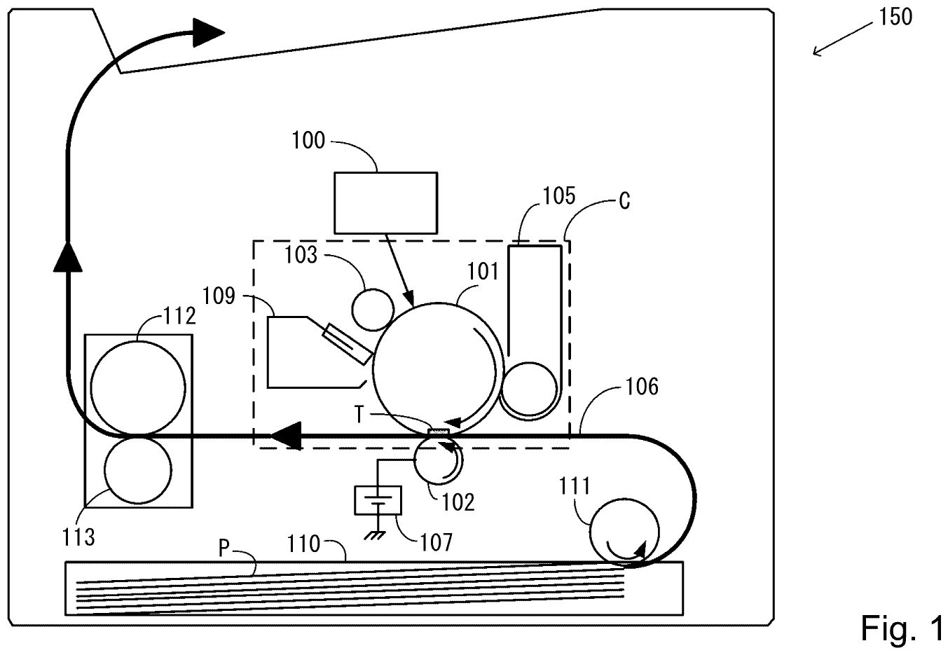

Using FIG. 1, an Embodiment 1 will be described. In the Embodiment 1, it will be described using a laser beam printer using an electrophotographic type as an example. FIG. 1 is a view illustrating an image forming apparatus 150. The image forming apparatus 150 is provided with a scanning optical device 100 as a laser scanning device. The image forming apparatus 150 is provided with a sheet feeding portion 110 on which a transfer material P is placed, a sheet feeding roller 111, a transfer roller 102 as a transfer means, a fixing roller 113 and a pressing roller 112 as a fixing means.

In addition, the image forming apparatus 150 is provided with a process cartridge C as an image forming means at a position, which is opposite to the transfer roller 102, on a conveying surface 106 which conveys the transfer material P. The process cartridge C is provided with a photosensitive drum 101 as an image bearing member. The process cartridge C is provided with a charging roller 103, a developing device 105 and a cleaner 109. The charging roller 103 uniformly charges a surface of the photosensitive drum 101. The developing device 105 as a developing means develops an electrostatic latent image on the photosensitive drum 101 by toner and forms a toner image T.

When a printing is started, the transfer material P is fed from the sheet feeding portion 110 by the sheet feeding roller 111, and by the transfer roller 102 to which a transfer voltage is applied by an applying portion 107, the toner image T formed on the photosensitive drum 101 is transferred to the transfer material P. Thereafter, by the fixing roller 113 and the pressing roller 112, the unfixed toner image T on the transfer material P is fixed on the transfer material P by heat and pressure. The transfer material P, on which the toner has been fixed, is outputted outside the image forming apparatus 150 by a discharging roller (not shown), and the printing is completed. Incidentally, the image forming apparatus to which the scanning optical device 100 of the present invention is mounted is not limited to the configuration described in FIG. 1.

### [Scanning Optical Device]

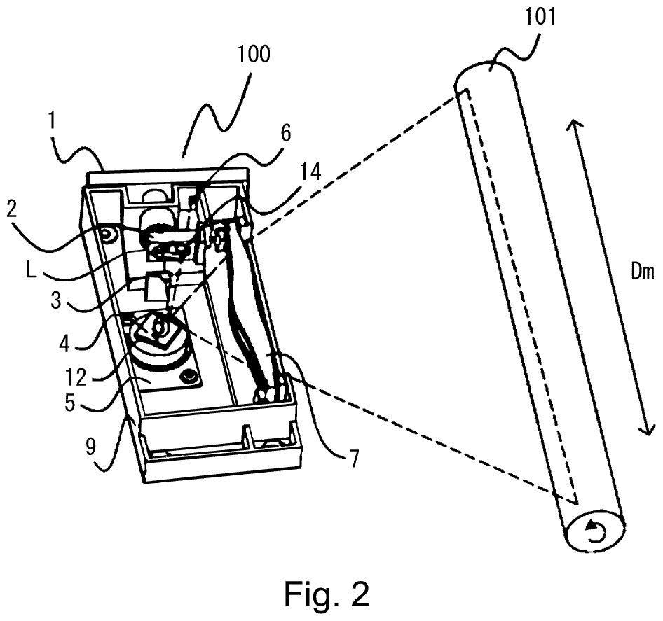

FIG. 2 is an explanatory view of the scanning optical device 100 in the Embodiment 1. In FIG. 2, the scanning optical device 100 is provided with a laser unit 1, an anamorphic collimator lens 2, an aperture diaphragm 3, a rotatable polygon mirror 4, a deflecting device 5, and a beam detector (hereinafter, referred to as a BD) 6, an fθ lens 7 and an optical box 9. The laser unit 1 emits a laser luminous flux L (light). The anamorphic collimator lens 2 is a lens in which a collimator lens, a cylindrical lens and a BD lens 14 are integrally molded. Incidentally, the BD lens 14 is a lens for guiding the laser luminous flux L reflected by the rotatable polygon mirror 4 to the BD 6. The rotatable polygon mirror 4 includes a plurality of (for example, four in FIG. 2) reflecting surfaces 12. The deflecting device 5 as a deflector rotationally drives the rotatable polygon mirror 4. The BD 6 detects the laser luminous flux L and outputs a synchronizing signal (writing start position signal). As shown in FIG. 2, the BD 6 receives the laser luminous flux L outside an area (area enclosed by broken lines) in which the laser luminous flux L is scanned on the photosensitive drum 101. The fθ lens 7 is a scanning lens. The optical box 9 accommodates the optical members described above. Incidentally, a direction in which the laser luminous flux L is scanned on the photosensitive drum 101 (rotational axis direction of the photosensitive drum 101) is referred to as a main scanning direction (Dm), and a direction perpendicular to the main scanning direction (rotational direction of the photosensitive drum 101) is referred to as a sub scanning direction.

In such a configuration, the laser luminous flux L emitted from the laser unit 1 is made to be an approximately collimated light or a converged light in the main scanning direction and the converged light in the sub scanning direction by the anamorphic collimator lens 2. Next, by passing through the aperture diaphragm 3, the laser luminous flux L is limited in a luminous flux width thereof, and is formed as an image having a focal line shape elongated in the main scanning direction on the reflecting surface 12 of the rotatable polygon mirror 4. Then, by rotating the rotatable polygon mirror 4, the laser luminous flux L is deflected and scanned. The reflected laser luminous flux L is incident on the BD lens 14 of the anamorphic collimator lens 2. The laser luminous flux L which has passed through the BD lens 14 is incident on the BD 6. At this time, the BD 6 as an output unit outputs the synchronizing signal in response to receiving the laser luminous flux L, and based on this timing, a writing timing of an image is determined.

Next, the laser luminous flux L is incident on the fθ lens 7 which is formed of an aspheric surface lens. The fθ lens 7 is designed to condense the laser luminous flux L to form a spot on the photosensitive drum 101 and to keep a scanning speed of the spot at a constant speed. The laser luminous flux L which has passed through the fθ lens 7 is formed in the image and scanned on the photosensitive drum 101. By rotation of the rotatable polygon mirror 4, the laser luminous flux L is deflected and scanned, and a main scanning is performed by the laser luminous flux L on the photosensitive drum 101, and in addition, by the photosensitive drum 101 being rotationally driven about an axial line of a cylinder thereof, a sub scanning is performed. As such, the electrostatic latent image is formed on the surface of the photosensitive drum 101.

Incidentally, in a case in which the scanning optical device 100 is to be classified as Class 3R defined by IEC60825-1, it is necessary to make a light amount of the laser luminous flux L, which passes through the fθ lens 7 and comes out of the scanning optical device 100, be a specified value or less. As described in the conventional example, when the laser luminous flux L is deflected and scanned by the rotatable polygon mirror 4, the light amount per unit area becomes smaller than when not deflected and scanned.

### [Control Configuration]

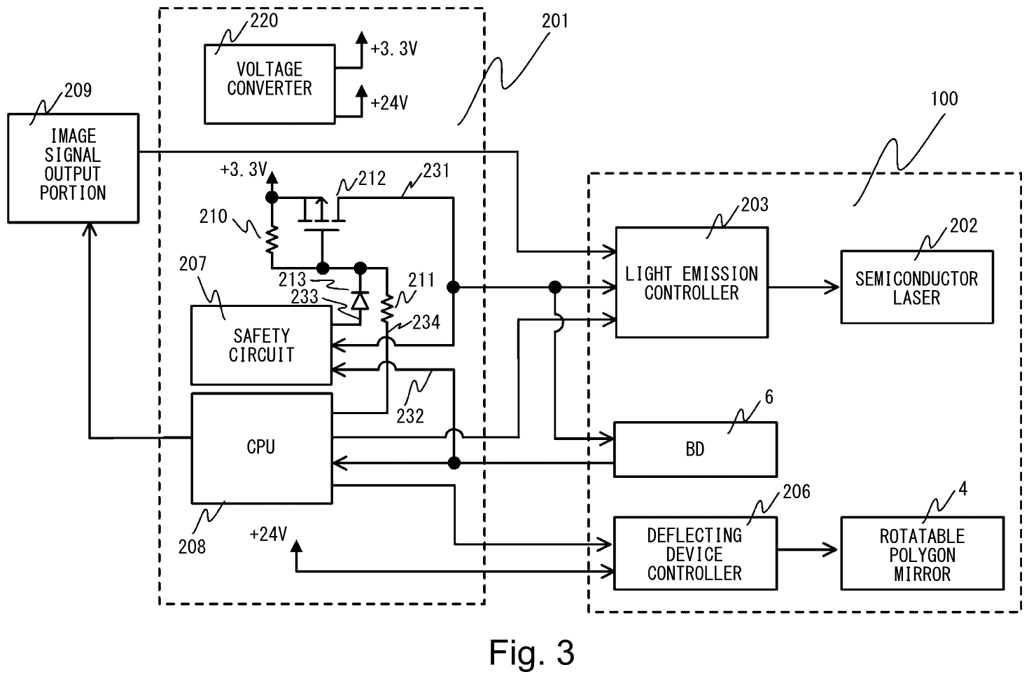

In FIG. 3, a block diagram of a portion related to control of the scanning optical device 100 in the Embodiment 1 is illustrated. The scanning optical device 100 is provided with a light emitting control portion 203 which performs a light emitting control of a semiconductor laser 202 (laser element), a deflecting device control portion 206 which rotationally drives the deflecting device 5 of the rotatable polygon mirror 4, and the BD 6 which outputs the synchronizing signal.

A main control portion 201 is provided with a voltage conversion circuit 220, a CPU 208, a safety circuit 207 and a load switch (hereinafter, referred to as a load SW) 212. The voltage conversion circuit 220 as a power source portion converts an alternating current voltage, which is supplied from an alternating current power source, to a direct current voltage. Incidentally, in the Embodiment 1, the voltage conversion circuit 220 outputs two systems of output voltage of +3.3 V and +24 V. Hereinafter, these two systems of the output voltage are also referred to as a 3.3V power source and a 24V power source. Incidentally, the 24V power source is supplied to the deflecting device control portion 206. The CPU 208 as a control unit is operated by a firmware. In addition, by an output voltage 234 as a control signal, which will be described below, the CPU 208 controls an ON state or an OFF state of the load SW 212. The safety circuit 207 is a protection circuit for the scanning optical device 100 and will be described below. The load SW 212 as a switching means is a switch which is constituted by a Pch MOSFET.

An image signal output portion 209 generates an image signal based on image information, which is inputted from an outside of the image forming apparatus 150. Based on the image signal supplied from the image signal output portion 209 and a laser control signal supplied from the CPU 208, the light emitting control portion 203 performs the light emitting control of the semiconductor laser 202.

The deflecting device control portion 206 rotationally drives the rotatable polygon mirror 4 based on a deflection control signal supplied from the CPU 208. The BD 6 sends a synchronizing signal 232 to the CPU 208 and the safety circuit 207. Incidentally, the synchronizing signal 232 becomes an output of high level when the laser luminous flux L is not incident on the BD 6, and an output of low level when the laser luminous flux L is incident on the BD 6.

The CPU 208 is operated by the firmware, performs various types of state detection of the image forming apparatus 150, and sends the control signals, at predetermined timings, to the image signal output portion 209, the light emitting control portion 203, the deflecting device control portion 206 and the load SW 212, respectively. The CPU 208 also performs controls of portions, which are not shown in FIG. 3, such as the sheet feeding roller 111, the transfer roller 102 and the fixing roller 113 described above.

Of the load SW 212, a source terminal is connected to the 3.3V power source of the voltage conversion circuit 220, and a drain terminal is connected to the light emitting control portion 203, the BD 6 and the safety circuit 207. By the load SW 212 being turned on, through a power supply line 231 as a supplying path, a 3.3V current is supplied to the scanning optical device 100. That is, the load SW 212 is provided in the power supply line 231 (in the supplying path) which supplies a current to the semiconductor laser 202. In more detail, by the load SW 212 being turned ON, through the power supply line 231, the 3.3V current is supplied to the light emitting control portion 203 and the BD 6 of the scanning optical device 100. That is, the load SW 212 is switched to the ON state in which the current is supplied to the semiconductor laser 202 and the OFF state in which the supply of the current to the semiconductor laser 202 is shut off. Incidentally, in the Embodiment 1, the load SW 212 is constituted by the Pch MOSFET, however, it is not limited thereto. For example, other semiconductor switches such as a transistor may be used as the load SW 212, or an electromagnetic switch may be used as the switching means. That is, any switching means, of which the ON state and the OFF state can be controlled by the safety circuit 207, which will be described below, may be used.

To a gate terminal of the load SW 212, a voltage of the 3.3V power source and the output voltage 234, which is outputted from the CPU 208, divided by voltage dividing resistors 210 and 211, and an output voltage 233 of the safety circuit 207 through a diode 213 are connected. Incidentally, of the diode 213, an anode terminal is connected to the safety circuit 207 and a cathode terminal is connected to the gate terminal of the load SW 212. The load SW 212 is turned ON, i.e., supplies the 3.3V power to a downstream side only when the output voltage 234 of the CPU 208 is a low level and the output voltage 233 of the safety circuit 207 is a low level. When the output voltage 233 of the safety circuit 207 is a high level, irrespective of the level of the output voltage 234 of the CPU 208, the load SW 212 becomes the OFF state.

By the way, in the laser scanning device, in a case in which it is configured that a laser cannot emit the light until a rotation state of the rotatable polygon mirror becomes a normal number of rotation, there are problems as follows. That is, in order to determine the rotation state of the rotatable polygon mirror before supplying electric power to a laser emitting portion, there is a problem that a circuit, which counts an FG signal (rotation angle signal) used for rotation control and determines the rotation state of a motor, is needed. To the laser scanning device which is mounted to the laser beam printer, etc., a synchronizing signal detecting means for performing synchronization of a light emitting timing of the laser is provided. If it is in a state in which the laser is emitted, it is possible to determine that, based on presence or absence of detection of the synchronizing signal, the laser is in a scanning state or a non-scanning state (stationary state).

Since it is not possible to make the laser emit a light at the same time as a startup of a rotating device of the rotatable polygon mirror, there is a problem that it takes a startup time of the laser scanning device. It also takes a time from when the laser emission is started until when a light amount of the laser emission is stabilized at a predetermined light amount. In order to shorten the startup time of the laser scanning device, it is necessary to start the laser emission at the same time as the startup of the rotating device of the rotatable polygon mirror.

In addition, an upper limit value for laser power in Class 3R, which is defined by IEC60825-1, has different specified values for each emission duration. For example, in a case of a laser light having a wavelength of 790 nm, which is used in the laser beam printer, etc., different upper limit values for emission of the laser power are defined when the emission duration is 100 seconds (10 seconds-30000 seconds category) and is 100 milliseconds (18 microseconds-10 seconds category). Even if the laser power emitted upon an abnormality exceeds the upper limit value of the 100 seconds category, it is sufficient that the safety circuit operates within the emission duration of 100 second and the laser power becomes a lower limit value of the 100 seconds category or less. Therefore, it is important to set an appropriate delay time to a time when the safety circuit operates. On the other hand, in a case in which the delay time for the operation of the safety circuit is managed by the firmware incorporated in the CPU, etc., if there is an abnormality in the firmware operation, the safety circuit may not operate properly. Thus, it is necessary that the safety circuit for the laser is constituted only by hardware which does not allow the firmware to intervene. Therefore, it is characterized in that the safety circuit in the present Embodiment has the following configuration.

### [Safety Circuit]

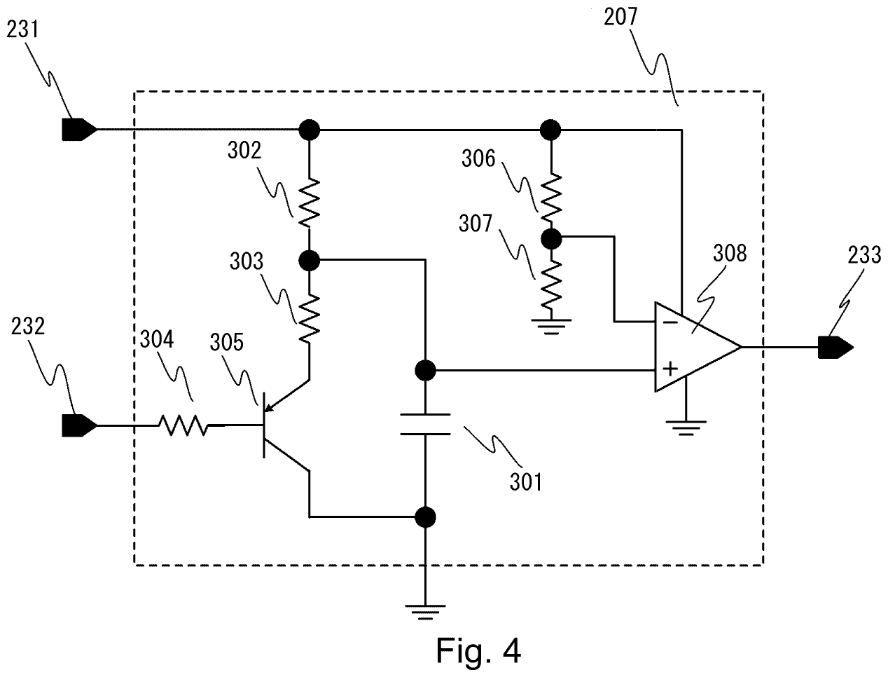

Using FIG. 4, a circuit configuration of the safety circuit 207 in the present Embodiment will be described. The safety circuit 207 as a protection circuit is a circuit to which the synchronizing signal 232 is inputted from the BD6, which changes the output voltage 233 (output) when a predetermined time depending on a time constant thereof elapses, and of which the output voltage 233 is connected to the load SW 212.

The safety circuit 207 includes a capacitor 301, resistors 302, 303 and 304, voltage dividing resistors 306 and 307, a transistor 305 and a comparator 308. In the transistor 305, to a base terminal, the synchronizing signal 232 of the BD 6 is connected through the resistor 304, to an emitter terminal, the power supply line 231 is connected through the resistor 302 and the resistor 303, and a collector terminal is grounded. That is, to the safety circuit 207, power is supplied by the voltage conversion circuit 220 through the load SW 212.

Of the capacitor 301, one end is connected to a connected point between the resistor 302 and the resistor 303, and the other end is grounded. The comparator 308 utilizes a voltage of the power supply line 231 as a power source, and an inverting input terminal (− terminal) thereof is connected to a connected point of the resistor 306 and the resistor 307, and a non-inverting input terminal (+ terminal) thereof is connected to one end of the capacitor 301. Of the resistor 306, one end is connected to the power supply line 231 and the other end is connected to one end of the resistor 307. Of the resistor 307, the other end is grounded.

To an input portion of the safety circuit 207, the synchronizing signal 232 from the BD 6 and the power supply line 231 are connected, and the output voltage 233 is outputted from an output portion. As described above, the output voltage 233 is connected to the gate terminal of the load SW 212 through the diode 213. To the base terminal of the transistor 305, the synchronizing signal 232 is connected through the resistor 304. When the synchronizing signal 232 is the low level, it becomes a conductive state between the collector terminal and the emitter terminal of the transistor 305. When the voltage of the power supply line 231 is 0 V, the output voltage 233 of the safety circuit 207 becomes the low level.

When 3.3 V is supplied to the power supply line 231, depending on input voltages of the inverting input terminal and of the non-inverting input terminal of the comparator 308, the output voltage 233 is determined to be the high level or the low level. To the inverting input terminal of comparator 308, a voltage of the power supply line 231 divided by the voltage dividing resistor 306 and the voltage dividing resistor 307 (hereinafter, referred to as a reference voltage) are inputted, and to the non-inverting input terminal, a charge voltage of the capacitor 301 is inputted. The output voltage 233 becomes the high level when the charge voltage of the capacitor 301 is higher than the reference voltage, and conversely, becomes the low level when the charge voltage of the capacitor 301 is lower than the reference voltage.

### (Determination of Time Constant)

When the synchronizing signal 232 is in the high level state, i.e., when the laser luminous flux L is not incident on the BD 6, the transistor 305 becomes a non-conductive state, so that the charge voltage of the capacitor 301 increases to the same voltage as the power supply line 231 with a time constant τ1 as a first time constant determined by an equation (1).

$$τ1 = ( resistance value of the resistor 302 ) \times ( electrostatic capacitance of the capacitor 301 ) \qquad Equation ( 1 )$$

When the load SW 212 is switched to the ON state, in a case in which the synchronizing signal 232 is not inputted from the BD 6, the charge voltage of the capacitor 301 increases with the time constant τ1. Incidentally, if the charge voltage of the capacitor 301 exceeds a predetermined voltage (the reference voltage), then the safety circuit 207 switches the load SW 212 to the OFF state.

On the other hand, when the synchronizing signal 232 is in the low level state, i.e., when the laser luminous flux L is incident on the BD 6, the transistor 305 becomes the conductive state, so that the charge voltage of the capacitor 301 decreases to 0 V approximately with a time constant τ2 as a second time constant of a following equation (2).

$$τ2 = ( resistance value of the resistor 303 ) \times ( electrostatic capacitance of the capacitor 301 ) \qquad Equation ( 2 )$$

When the load SW 212 is switched to the ON state, in a case in which the synchronizing signal 232 is inputted from the BD 6, the charge voltage of the capacitor 301 decreases with the time constant τ2.

In the Embodiment 1, the resistance value of the resistor 303 is set to 1/100 of the resistance value of the resistor 302 or less (resistance value of R303≤( 1/100)×resistance value of the resistor 302), and the constant is selected so that relationship of τ1>>τ2 is maintained. That is, in the Embodiment 1, the resistance value of the resistor 302 is set larger than the resistance value of the resistor 303, so that the time constant τ1 is larger than the time constant τ2. The synchronizing signal 232 becomes the low level output only when the laser luminous flux L is incident on the BD 6. In a state in which the rotatable polygon mirror 4 is rotated at a constant speed, a time during which the synchronizing signal 232 becomes the low level output is approximately a frequency of 1/50 of a time becoming the high level output (referring to FIG. 2). Therefore, it is important to set τ1>>τ2. The time constant τ1 is set based on the emission duration of the laser defined by IEC60825-1 as safety standards.

As such, the capacitor 301, the resistor 302 and the resistor 303 function as a state holding portion which transits with the time constant. When the load SW 212 is switched to the ON state, the state holding portion transits toward a first state with the first time constant τ1 in the case in which the synchronizing signal 232 is not inputted from the BD 6. On the other hand, the state holding portion transit toward a second state different from the first state with the second time constant τ2 smaller than the first time constant τ1 in the case in which the synchronizing signal is inputted from the BD 6.

When the state holding portion transits to the first state with the first time constant τ1, the state holding portion switches the load SW 212 to the OFF state. Incidentally, the first state is a state in which the capacitor 301 is charged and the charge voltage increases and exceeds the predetermined voltage. The second state is a state in which the capacitor 301 is discharged and the charge voltage decreases.

In Class 3R in a vicinity of a wavelength of 790 nm, which is mounted to the laser beam printer, as described above, the upper limit standard of the laser power is defined with the emission duration of 100 seconds. Therefore, for example, it is set so that the safety circuit 207 operates at 50 seconds. That is, the resistance values of the resistor 302 and the electrostatic capacitance of the capacitor 301 are selected so that the time constant τ1 is 50 seconds. It is sufficient to set the voltage dividing resistors 306 and 307 so that the reference voltage, which is the power supply line 231 divided by the voltage dividing resistors 306 and 307, is approximately 63.2% of the voltage of the power supply line 231, for example.

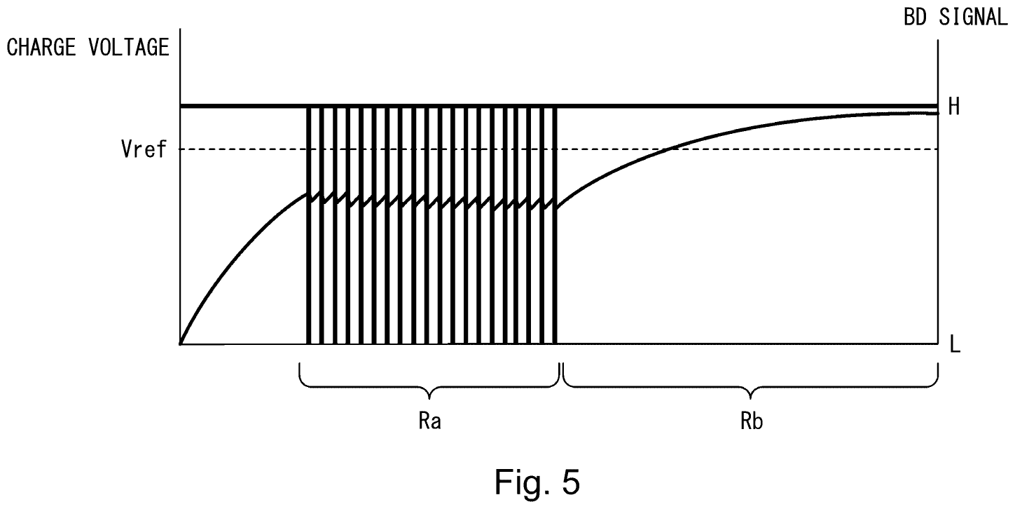

Here, FIG. 5 is a view illustrating a relationship between the charge voltage of the capacitor 301 and a BD signal, and a left vertical axis thereof represents the charge voltage of the capacitor 301 and a right vertical axis thereof represents the synchronizing signal 232 as the BD signal (high level (H) and low level (L)). A horizontal axis represents time for both vertical axes. In addition, the reference voltage described above is shown as Vref (broken line). Ra indicates an area in which the synchronizing signal 232 (BD signal) is normally inputted to the safety circuit 207. On the other hand, Rb indicates an area in which the synchronizing signal 232 (BD signal) is not inputted to the safety circuit 207. In the area Ra, since the synchronizing signal 232 periodically repeats the high level and the low level, by the voltage of the capacitor 301 repeatedly being charged and discharged, the charge voltage of the capacitor 301 does not exceed the reference voltage Vref. At this time, the safety circuit 207 outputs the output voltage 233 of the low level. However, in the area Rb, the synchronizing signal 232 is fixed at the high level, so that the charge voltage of the capacitor 301 continues to increase, and exceeds the reference voltage Vref. By this, the safety circuit 207 outputs the output voltage 233 of the high level, irrespective of the level of the output voltage 234 of the CPU 208, switches the load SW 212 to the OFF state and the power supply line 231 is shut off.

As such, the safety circuit 207 changes the output in a case in which the synchronizing signal 232 is not inputted from the BD 6 for the predetermined time from when the load SW 212 is switched to the ON state by the output voltage 234 of the CPU 208. The safety circuit 207 switches the load SW 212 to the OFF state irrespective of the state of the output voltage 234 of the CPU 208.

As described above, after the CPU 208 turns the load SW 212 ON, it is operated as follows. In a case in which neither an instruction for rotational drive of the rotatable polygon mirror 4 is not given to the deflecting device control portion 206 nor an instruction for light emission of the semiconductor laser 202 is not given to the light emitting control portion 203 within the operation time of the safety circuit 207, which is determined by the time constant TI, the safety circuit 207 operates and the load SW 212 is forcibly switched OFF.

It is because, in such the state, the synchronizing signal 232 is not inputted to the safety circuit 207. For example, also in a case in which the rotational drive of the rotatable polygon mirror 4 is not started within the predetermined time after the CPU 208 turns ON the load SW 212 due to a malfunction of the deflecting device control portion 206, etc., the safety circuit 207 operates and the load SW 212 is forcibly switched OFF. Also in a case in which the rotational drive of the rotatable polygon mirror 4 is not started within the predetermined time after the CPU 208 turns ON the load SW 212 due to a malfunction of the light emitting control portion 203, etc., the safety circuit 207 operates and the load SW 212 is forcibly switched OFF. It is because, in both cases, the synchronizing signal 232 is not inputted to the safety circuit 207.

As described above, irrespective of the operation of the CPU 208, in the cases in which the synchronizing signal 232 is not outputted for the predetermined time after the semiconductor laser 202 is in a state capable of emitting the light, by the safety circuit 207 which operates with the time constant TI, the laser emission is forcibly switched OFF. By this, in the Embodiment 1, it becomes possible to provide an inexpensive and safe scanning optical device.

As described above, according to the Embodiment 1, when the abnormality occurs during laser emission, even in the case in which there is the abnormality in the firmware operation, it becomes possible to make the safety circuit of the laser scanning device operate reliably.

### Embodiment 2

A scanning optical device in an Embodiment 2 will be described. For the same configurations as in the Embodiment 1, the same reference numerals are used, and description thereof will be omitted. In the case of the configuration of the safety circuit 207 described in the Embodiment 1, after the safety circuit 207 operates and the load SW 212 is turned OFF, when the voltage of the power supply line 231 decreases, the load SW 212 is turned ON again. In the Embodiment 2, it is characterized to configure that, after a safety circuit 207A operates, the safety circuit 207A is latched until the 3.3V power source of the voltage conversion circuit 220 is turned OFF, and the forced OFF of the load SW 212 is continued.

### [Safety Circuit]

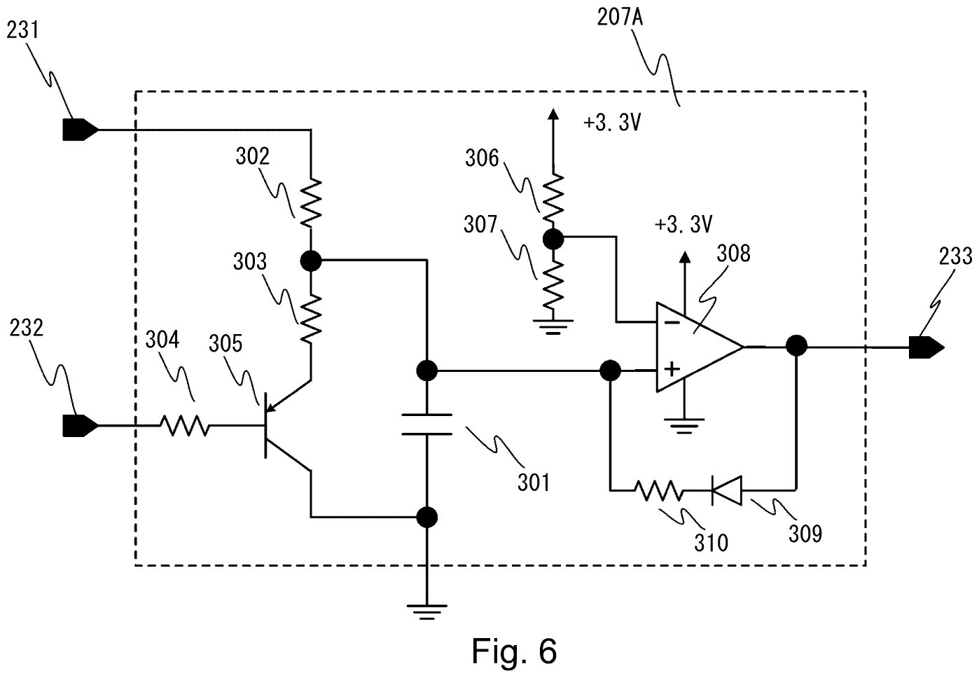

A specific configuration will be described using FIG. 6. The safety circuit 207A is a configuration which maintains the OFF state of the load SW 212 until a supply of a current stops in a case in which the charge voltage of the capacitor 301 exceeds the reference voltage Vref and the load SW 212 is switched to the OFF state. Of the resistor 306 of the safety circuit 207A, one end is connected to the 3.3V power source instead of the power supply line 231. That is, to the safety circuit 207, the power is supplied by the voltage conversion circuit 220 without going through the load SW 212. In contrast to the safety circuit 207 described in the Embodiment 1, it is configured that the power source for the comparator 308 is changed to the 3.3V power source of the voltage conversion circuit 220, and the output of the comparator 308 is connected to the non-inverting input terminal and to the capacitor 301 through a diode 309 and a resistor 310.

In a state in which the safety circuit 207A does not operate, the output voltage 233 of the comparator 308 is the low level, so that no current flows from an output terminal to the non-inverting input terminal side of the comparator 308. On the other hand, when the safety circuit 207A operates and the output voltage 233 becomes the high level, the current flows from the output terminal to the non-inverting input terminal side through the diode 309 and the resistor 310. By the current flowing from the output terminal side to the capacitor 301, the voltage of the non-inverting input terminal is maintained at a higher voltage than a voltage of the inverting input terminal, so that the safety circuit 207A can continue the operation even in the state in which the voltage of the power supply line 231 decreased.

As described above, by configuring the circuit as shown in FIG. 6, irrespective of the operation of the CPU 208, in the case in which the safety circuit 207A operates, it becomes possible to continue the prohibited state of the laser emission until a power source of the image forming apparatus 150 itself is turned OFF. By this, it become possible to provide an inexpensive and safe scanning optical device.

As described above, according to the Embodiment 2, when the abnormality is occurred during the laser emission, even in a case in which there is the abnormality in the firmware operation, it becomes possible to make the safety circuit of the laser scanning device operate reliably.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-082854 filed on May 21, 2024, which is hereby incorporated by reference herein in its entirety.

What is claimed is:

1. A scanning optical device comprising:
a laser element;
a deflector configured to deflect a light emitted from the laser element;
an output unit configured to receive the light deflected and scanned by the deflector and to output a synchronizing signal;
a switch provided in a supplying path which supplies a current to the laser element and configured to be switched to an ON state in which the current is supplied to the laser element and to an OFF state in which the supply of the current to the laser element is shut off;
a control unit configured to control the ON state and the OFF state of the switch by a control signal; and
a protection circuit to which the synchronizing signal is inputted from the output unit, configured to change an output when a predetermined time depending on a time constant thereof elapses, and of which the output is connected to the switch,
wherein the protection circuit changes the output, in a case in which the synchronizing signal is not inputted from the output unit for the predetermined time from when the switch is switched to the ON state by the control signal of the control unit, and thereby the switch is switched to the OFF state irrespective of a state of the control signal of the control unit.

2. The scanning optical device according to claim 1, wherein the protection circuit includes a state holding portion configured to transit with the time constant,
wherein when the switch is switched to the ON state, the state holding portion transits toward a first state with a first time constant in a case in which the synchronizing signal is not inputted from the output unit, and the state holding portion transits toward a second state different from the first state with a second time constant smaller than the first time constant in a case in which the synchronizing signal is inputted from the output unit, and
wherein when the state holding portion transits to the first state with the first time constant, the state holding portion switches the switch to the OFF state.

3. The scanning optical device according to claim 2, wherein the state holding portion includes a capacitor, and
wherein the first state is a state in which the capacitor is charged and a charge voltage increases and exceeds a predetermined voltage and the second state is a state in which the capacitor is discharged and the charge voltage decreases.

4. The scanning optical device according to claim 1, wherein the protection circuit includes a capacitor, and
wherein when the switch is switched to the ON state, a charge voltage of the capacitor increases with a first time constant in a case in which the synchronizing signal is not inputted from the output unit and the charge voltage of the capacitor decreases with a second time constant smaller than the first time constant in a case in which the synchronizing signal is inputted from the output unit, and
wherein when the charge voltage of the capacitor exceeds a predetermined voltage, the protection circuit switches the switch to the OFF state.

5. The scanning optical device according to claim 4, wherein the first time constant is set based on an emission duration of a laser defined by IEC60825-1 as safety standards.

6. The scanning optical device according to claim 1, further comprising a power source portion configured to supply a power to the protection circuit,
wherein the protection circuit is supplied with the power by the power source portion through the switch.

7. The scanning optical device according to claim 4, wherein the protection circuit maintains the OFF state of the switch until the current is not supplied in a case in which the charge voltage of the capacitor exceeds the predetermined voltage and the switch is switched to the OFF state.

8. The scanning optical device according to claim 7, further comprising a power source portion configured to supply a power to the protection circuit,
wherein the protection circuit is supplied with the power by the power source portion not through the switch.

9. An image forming apparatus comprising:
a scanning optical device according to claim 1;
an image bearing member on which an electrostatic latent image is formed by the scanning optical device;
a developing unit configured to develop the electrostatic latent image with toner and form a toner image;
a transfer unit configured to transfer the toner image onto a transfer material; and
a fixing unit configured to fix the toner image transferred by the transfer unit.
